(19) United States
(12) Patent Application Publication
(10) Pub. No.: US 2009/0190108 A1
(43) Pub. Date: Jul. 30, 2009

(54) METHOD AND SYSTEM FOR LEVELING TOPOGRAPHY OF SEMICONDUCTOR CHIP SURFACE

(75) Inventors: Tatsuhiko Ema, Sommers, NY (US); Kenji Konomi, Fishkill, NY (US)

Correspondence Address: BANNER & WITCOFF, LTD., 1100 13th STREET, N.W., SUITE 1200, WASHINGTON, DC, 20005-4051, US

(73) Assignee: TOSHIBA AMERICA ELECTRONIC COMPONENTS, INC., Irvine, CA (US)

(21) Appl. No.: 12/022,560

(22) Filed: Jan. 30, 2008

(51) Int. Cl. G03B 27/42; G03B 27/68

(52) U.S. Cl. 355/52; 355/53

(57) ABSTRACT

A system and method of leveling the topography of a semiconductor wafer surface is presented. The system may induce low-order lens aberration to control the focal plane dynamically. The system may include a leveling sensor which measures the changes in topography on the surface, as well as an analyzer to determine the aberration to be induced. In addition, the system may include a controller that dynamically adjusts at least one lens to induce such aberration. In another arrangement, the system may control the focal plane by dividing the exposure slit into smaller slits. In this arrangement, the analyzer may be used to determine the appropriate number of divisions to make to produce a focal plane that closely matches the surface of the wafer. In addition, the controller may adjust the stage height and tilt for each division to produce such a focal plane.

### BACKGROUND

Lithographic techniques are essential to semiconductor manufacturing. In a nutshell, a photo-resist material is applied to the surface of a semiconductor substrate, and a high definition image of a layer of circuitry is exposed onto the photo-resist. The exposure of light onto portions of the photo-resist causes those portions to either be easily washed away or prevents those portions from being washed way, depending upon the type of photo-resist used. Because a patterned version of the photo-resist remains, the next application of a material or etching solution may be masked by the patterned photo-resist, resulting in a patterned application of the material or etching solution. This allows one to add material, dope, or etch in a controlled manner to form, for example, transistor gates or other conductive pathways, doped source/drain regions, or trenches.

However, because of the high accuracy required during lithography, the process is extremely sensitive to the topographic heights of the substrate being exposed. Unless the topographical variations of the surface of a semiconductor substrate are accounted for, they can significantly deteriorate lithographic performance by reducing the common depth of focus for the entire chip field. This problem has become more serious with the increasing use of high numerical aperture (NA) lithography, which uses an extremely thin optical focal plane. Conventional scan exposure systems deal with the topography of the chip by leveling. This method can reduce the focus difference across the entire chip field by changing stage height and tilt during scanning to help even out the topography. In conventional leveling, the stage moves in a z-direction and follows the topography profile. Leveling is used for correcting for changes in topography in the scan direction.

However, in the slit direction, the focus difference is reduced only by stage tilting. Stage tilting results in portions of the semiconductor device being intrinsically outside of the focal plane. This deteriorates lithographic performance by causing critical dimension (CD) error or failures such as pattern collapse or pattern scumming. In some cases, stage tilting can also cause the exposure in general to be out of focus.

### SUMMARY

This summary is provided to introduce a selection of concepts in a simplified form that are further described below in the Detailed Description. This summary is not intended to identify key features or essential features of the claimed subject matter.

There is a need for a system of leveling the topography of a semiconductor surface in the slit direction. Accordingly, a method and system of leveling in the slit direction is presented. The system may include an illumination system, a reticle scan stage, a wafer scan stage and at least one projection lens. In addition, the system can include a leveling sensor, an analyzer and a controller.

In one arrangement, the system levels the topography by inducing a low-order lens aberration in addition to stage tilt. In order to induce such aberration, a system may include multiple independently adjustable projection lenses. In addition, the system may include a focal plane control lens to further improve response time.

Further to this arrangement, the topography of the chip may be measured via a leveling sensor. The measured topographical information (e.g., height of the wafer at a given location) is then sent to an analyzer that determines the aberration to induce based on the topographical information. This information is then transmitted to a controller that adjusts the lenses and stage tilt to induce such aberration. The controller is able to dynamically adjust one or more of the lens positions to provide a focal plane that closely approximates the topography of the portion of the wafer being exposed.

Additionally or alternatively, the exposure slit may be split into multiple smaller slits to provide a focal plane that approximates the topography of the portion of the wafer being exposed. The analyzer may receive the height information from the leveling sensor and use it to determine the appropriate number of slits to implement. This information may then be transmitted to the controller that then may control stage height and tilt dynamically for each slit. In addition, dose profile can be controlled in order to compensate for flare.

These and other aspects of the disclosure will be apparent upon consideration of the following detailed description of illustrative embodiments.

### BRIEF DESCRIPTION OF THE DRAWINGS

A more complete understanding of the present invention and the advantages thereof may be acquired by referring to the following description in consideration of the accompanying drawings, in which like reference numbers indicate like features, and wherein:

FIG. 1 is a schematic of an illustrative exposure system according to one configuration.

FIG. 2 is a schematic of an illustrative lens configuration according to one arrangement.

FIG. 3 is schematic of another illustrative lens configuration according to one arrangement.

FIG. 4 is a cross sectional view of a semiconductor surface showing an illustrative focal plane that may be produced with a conventional system.

FIG. 5 is a cross sectional view of a semiconductor surface showing an illustrative focal plane that may be produced.

FIG. 6 is a flow diagram showing illustrative steps of a method of leveling.

FIG. 7 is a cross sectional view of a semiconductor surface showing another illustrative focal plane that may be produced.

FIG. 8 is a flow diagram showing illustrative steps of another method of leveling.

### DETAILED DESCRIPTION

The various aspects summarized previously may be embodied in various forms. The following description shows by way of illustration various embodiments and configurations in which the aspects may be practiced. It is understood that other embodiments may be utilized and structural and functional modifications may be made, without departing from the scope of the present disclosure.

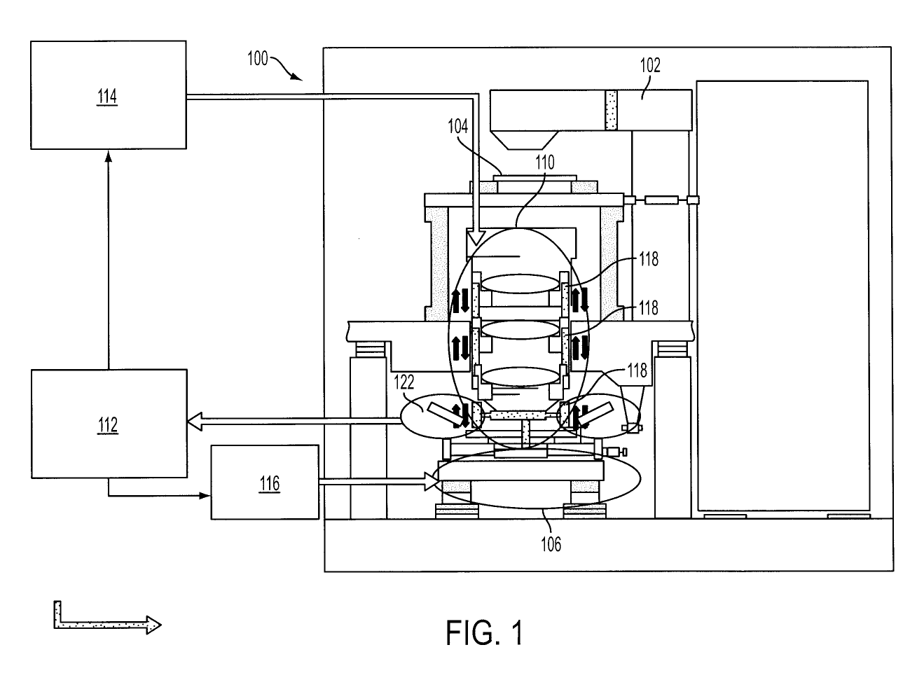

One illustrative configuration of a system of leveling is shown in FIG. 1. The system 100 can include an illumination system 102, a reticle scan stage 104, a wafer scan stage 106 and at least one projection lens. In the shown arrangement, three lenses 110 are used to project onto the semiconductor wafer. In addition to these features, the system 100 may also include a leveling sensor 122 to measure the height of the wafer surface, an analyzer 112 to determine the adjustments to be made to produce the desired focal plane and a controller 114 to adjust the lenses 110 based on the output of the analyzer 112.

According to one arrangement, the system 100 of FIG. 1 uses lens aberration to improve lithographic performance. For instance, introduction of a low order aberration by adjusting one or more of the lenses 110 may allow the focal plane to more closely match the topography of the portion of the wafer surface being exposed. In conventional systems, aberration was generally something to be avoided. In this arrangement, aberration is purposely induced to produce an advantageous focal plane. The term focal plane, as used herein, is not limited to a flat plane as has been used in conventional systems. In order to induce this aberration, lenses may be tilted to adjust the focal plane to more closely match the topography of the wafer portion.

The lenses 110 may each be tilted independently of the others of the lenses 110, in order to introduce the desired aberration. In the arrangement shown in FIG. 1, for example, three lenses 110 are used. For ease of understanding, the three lens system 110 will be used to describe aspects of the system. However, this description of the three lens system is not intended to limit the system to use with three lenses, and any number of lenses may be used.

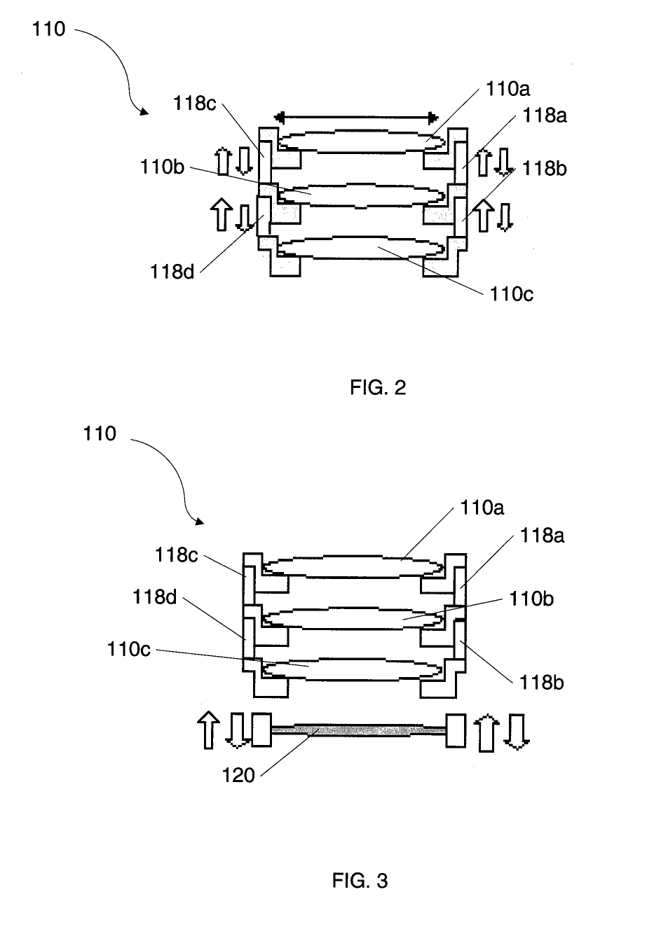

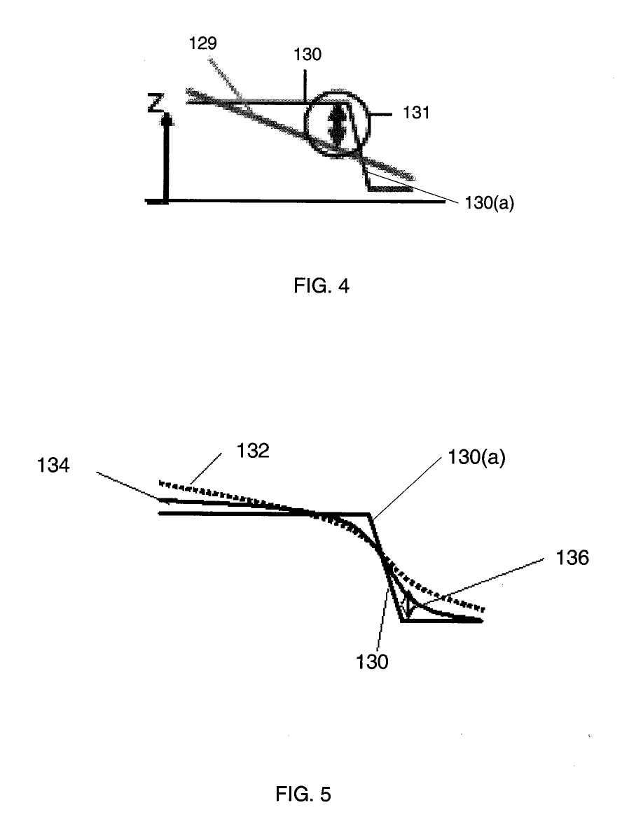

In the three lens system 110 of FIG. 1, the tilt of each lens and/or the distances between the lenses may be independently adjusted. For example, referring to FIG. 2, the tilt and distance of the top two lenses 110a, 110b may be adjusted independently of each other, while the third lens 110c remains stationary. Adjustment of the lens may be implemented, for example, by one or more Piezo-electric devices 118a, 118b, 118c, 118d controlling the tilt and/or position of each of the lenses. For example, in order to induce a desired aberration, Piezo-electric device 118a may cause a portion of the lens 110a to be raised, while Piezo-electric device 118c remains stationary. And, for example, Piezo-electric device 118b may cause a portion of the lens 110b to tilt in one direction, while Piezo-electric device 118d causes the lens 110c to tilt in an opposite direction. In another example, Piezo-electric devices 118a and 118d might remain stationary while Piezo-electric devices 118b and 118c cause lenses 110a and 110c to tilt. Thus, lenses 110a, 110b, 110c may be adjusted in any combination of tilts and positions desired. This arrangement, in particular, using a three-lens system 110 may provide a focal plane shaped to follow any second order curve, such as one that closely approximates the topography of the wafer surface portion being exposed. As shown in FIG. 3, a fourth lens 120 may be added to the lens system 110. The top three lenses in this embodiment may be stationary. However, more generally speaking, in both of the embodiments of FIGS. 3 and 4, one or more of the lenses may be stationary while the remaining lenses are adjustable. Or, all of the lenses may be adjustable

As each of the lenses 110a, 110b, 100c is tilted, it induces an aberration in the focal plane. The accumulated aberration results in (in the present example) a second-order aberration in the focal plane. The order of the curve that the focal plane follows depends upon the number of lenses being used and adjusted. For instance, two lenses can be used to provide a first-order curved focal plane, three lenses can be used to provide a second-order curved focal plane, and four lenses can be used to provide a third-order curved focal plane, etc.

In order to determine the amount of adjustment for each lens, the analyzer 112 may receive height information from the leveling sensor 122. As the wafer is scanned, portion by portion, the leveling sensor 122 may determine the heights of the wafer surface at the various portions across the wafer. Leveling sensors are generally known in the art and exist in conventional lithographic systems. The height of the wafer surface at various locations is then transmitted from the sensor 122 to the analyzer 112 where the information may be processed to determine the adjustments to be made to the lenses 110 to produce the appropriate focal plane.

Once the appropriate focal plane has been determined, the analyzer 112 outputs this information to the controller 114, which may adjust one, some, or all of the lenses 110 to introduce the appropriate aberration based on the wafer height information, to closely match the topography of the wafer portion to be illuminated. Such controlling may be done by the Piezo-electric devices 118a, 118b, 118c, 118d. Controlling such devices may be generally known in the art. In another example, the Piezo-electric devices 118a, 118b, 118c, 118d may adjust an additional aberration lens 120. This analysis and control system 112 and 114 can dynamically calculate and control the lenses 110 in real time, as the scan is performed, to provide a focal plane for each wafer portion that approximates the topography of the surface of that wafer portion.

FIG. 4 shows a cross section of an illustrative portion of the wafer surface 130. The topography of the wafer surface is shown having a step change 130(a). This step results in a difference in height on the surface 130 of the chip. Line 129 represents the focal plane produced when using a conventional system. By tilting the lens of the system, a zero-order tilted focal plane may be produced. As can be seen, focal plane 129 does not closely match the topography of the surface 130 of the chip. The large difference between the focal plane 129 and the surface 130 is visible in area 131.

In contrast, FIG. 5 shows a cross section of an illustrative portion of the wafer surface 130 where a second-order focal plane is induced that more closely follows the topography of the wafer portion to be illuminated. Again, the topography of the wafer surface 130 portion is shown having a step change 130(a) in the level of the surface 130.

As previously mentioned, such height differences may deteriorate lithographic performance because the distance from the surface 130 to the lens system 110 changes depending upon the location on the surface 130. An illustrative second-order focal plane formed using the system of FIG. 1 is also indicated with a broken line 132. Another example of a second-order focal plane is indicated in FIG. 4 with a solid line 134. The focal plane indicated by line 134 more closely follows the topography of the surface than line 132. The focal plane indicated by line 134 may better account for variations in the topography. The degree to which the focal plane 132 or 134 matches the topography of the wafer surface 130 portion is determined by the tilts of the lenses 110a, 110b, 110c based on the output from the analyzer 112. In addition, a threshold value 136 may be set such that the focus difference between the wafer surface and the focal plane should be determined to be no larger than the threshold value 136 at any given point on the wafer surface 130 portion.

In order to improve response time, a fourth lens 120 may be added to the system, as shown in FIG. 3. With the addition of this fourth lens 120, the top three lenses 110 may remain fixed, while the fourth lens 120 is adjustable. The fourth lens 120 may be smaller than the top three lenses 110. This smaller lens, as well as the movement of one lens, may improve response time.

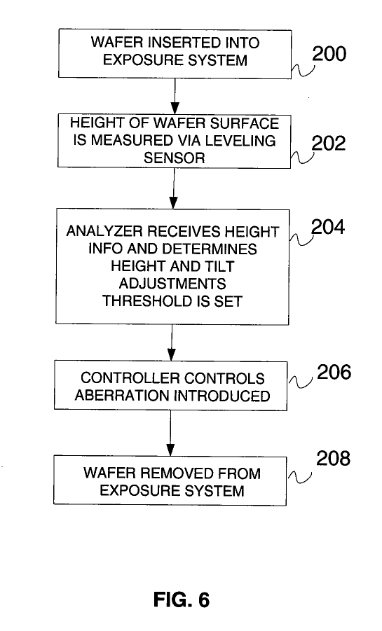

FIG. 6 provides one example of a method of using the system of FIG. 1. To begin, a semiconductor wafer, such as a bulk silicon wafer or a silicon-on-insulator wafer, is inserted into the system 100, as seen in step 200. Next, the height of the wafer surface is measured using the leveling sensor 122, as seen in step 202. In step 204, the analyzer 112 receives the height information from the leveling sensor 122 and determines the appropriate height and tilt for each portion of the wafer to be exposed. The threshold value 136 may also be defined or acknowledged in step 204 for the maximum focus difference between the chip surface and the focal plane. The threshold value 136 may be adjusted on a wafer-by-wafer basis or even a wafer-portion-by-wafer-portion basis. In step 206, the controller 114 controls the aberration to be introduced by adjusting the height and/or tilt of one or more of the lenses 110. The height and tilt of the lenses 110 during each scanning exposure may be dynamically adjusted in real time, during the scan, by the controller 114.

In step 208, the wafer is removed from the system 100. In one configuration, the aberration analysis may be performed once on a certain wafer or wafer portion to determine the dynamic adjustments to be made to the focal plane. Information indicating the adjustments made over time may be stored in memory or another computer-readable medium, such that when further identical wafers are exposed by the system 100, these adjustments need not be re-determined but instead read from memory. This can speed up the exposure process dramatically when a large number of identical wafers are being exposed in series. Alternatively, the aberration adjustments may be determined from scratch for each individual wafer.

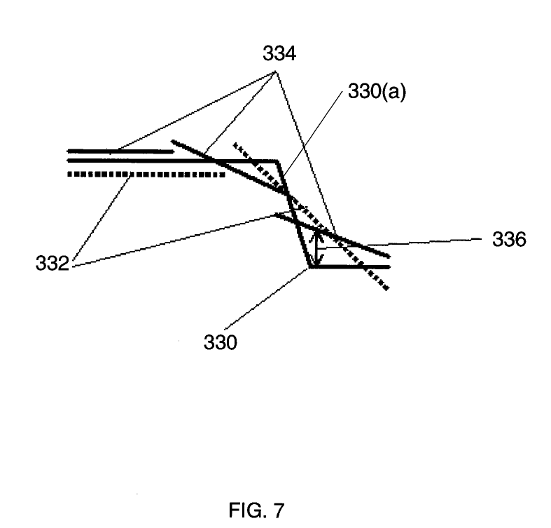

In another configuration, the exposure slit may be divided or split into more than one smaller slit. This configuration may allow the focal plane to more closely follow the topography of the wafer surface. FIG. 7 is a cross section of the surface of a wafer portion 330 wherein a focal plane is produced utilizing a split exposure slit configuration.

The surface 330 of the wafer portion is seen to have a step change 330(a) in height. In order to accommodate these height differences, the exposure slit may be split into two or more smaller slits to expose only sub-portions of the wafer surface at any given time. In one arrangement, the size of the slit is adjusted using blind aperture to physically adjust the size of the slit.

Broken line 332 indicates an example of a focal plane that may be produced when two slits are used. Solid line 334 shows an example of a focal plane that may be produced using three slits. Although the system is shown with two or three slits being used, any number of slits may be utilized. In one arrangement, the number of slits correlates to the number of inflection points for a given focal plane. For example, the slit number Sₙ and the number of inflection points for a given aberration plane Aₙ can be correlated using the following equation:

Sₙ=Aₙ+2

That is, in an arrangement where there is no inflection point, the number of slits would be 2. In another example, if there is one inflection point, the number of slits would be 3.

As before, a threshold value 336 may be defined such that the focus difference between the wafer surface and the focal plane should be no larger than the threshold value 336 at any given location.

The analyzer 112 may be used to determine the appropriate number of slits and the information may be transmitted to a controller 116. The controller 116 then controls the stage height and tilt for each split to provide a focal plane that closed matches the topography of the chip surface. The controller 116 may also control the dose profile within each slit to compensate for flare. Flare may be a kind of leakage dose from the edge of the slit. The dose profile may be controlled by a filter, such as a neutral density (ND) filter.

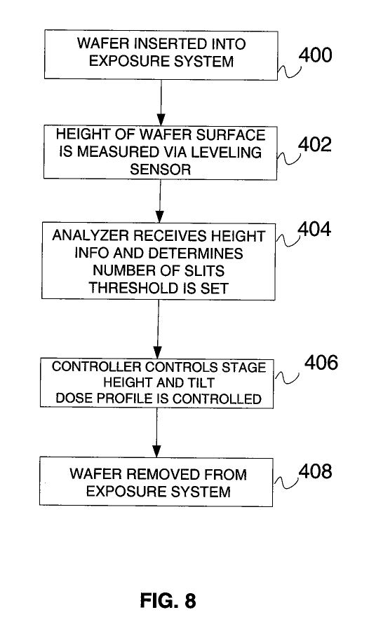

FIG. 8 provides one example of a method using this configuration. To begin, a wafer is inserted to the exposure system, as in step 400. Next, the height of the wafer surface is measured with a leveling sensor, as in step 402. In step 404 an analyzer receives this height information and determines the appropriate number of slits, as well as the stage height and tilt for each slit. A threshold is also set in step for the focus difference between the chip surface and the focal plane of the slit. This threshold may be set for the difference to be less than a predetermined value. In step 406, the controller dynamically controls the stage height and tilt for each slit. In addition, the dose profile is also controlled within each slit to compensate for flare. In step 408 the wafer is removed from the exposure system

What is claimed is:

1. A lithography exposure system for a semiconductor wafer, comprising:
a plurality of lenses configured to pass light onto the semiconductor wafer;
a sensor configured to measure a topography of the semiconductor wafer and to generate topographical data representing the topography of the semiconductor wafer;
an analyzer configured to receive the topographical data from the sensor and determine an aberration in a focal plane to be induced; and
a controller configured to adjust at least one of the plurality of lenses to induce the aberration.

2. The system of claim 1, wherein the plurality of lenses comprises at least three lenses.

3. The system of claim 2, further comprising a fourth lens that is a focal plane control lens.

4. The system of claim 1, wherein the controller is configured to adjust a tilt of the at least one of the plurality of lenses.

5. The system of claim 4, wherein the adjustment is made dynamically depending upon the topography of a portion of the semiconductor wafer presently being scanned.

6. A method of lithographic exposure for a semiconductor wafer, comprising the steps of:
measuring a topography of at least first and second portions of the semiconductor wafer;
determining a first aberration in a focal plane to be induced based on the topography of the first portion of the semiconductor wafer;
adjusting a plurality of lenses to induce the first aberration; and
exposing light onto the semiconductor wafer through the plurality of lenses such that the light is focused on the semiconductor wafer with the focal plane having the first aberration.

7. The method of claim 6, further including:
determining a second aberration in a focal plane to be induced based on the topography of the second portion of the semiconductor wafer;
adjusting a plurality of lenses to induce the second aberration; and
exposing light onto the semiconductor wafer through the plurality of lenses such that the light is focused on the semiconductor wafer with the focal plane having the second aberration.

8. A method of lithographic exposure for a semiconductor wafer, comprising the steps of:
measuring a topography of the semiconductor wafer;
determining a number of exposure slits based on the topography; and
exposing light through the determined number of exposure slits onto the semiconductor wafer.

9. The method of claim 8, wherein the step of controlling further comprises controlling an optical dose profile within each exposure slit to compensate for flare.
